(19) United States
(12) Patent Application Publication
(10) Pub. No.: US 2006/0196930 A1
(43) Pub. Date: Sep. 7, 2006

(54) Categorization of financial transactions

(76) Inventors: Matt E. Hart, Lunenburg, MA (US); Gordon D. Whitten JR., Omaha, NE (US); Rupesh Dilip Shah, San Francisco, CA (US); Kevin M. Reeth II, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/073,396

(22) Filed: Mar. 4, 2005

(51) Int. Cl. G06K 5/00; G06Q 40/00

(52) U.S. Cl. 235/380; 705/41

(57) ABSTRACT

A user records categorization information on a financial instrument used to conduct a financial transaction. A financial entity that handles the financial instrument processes the categorization information recorded on the financial instrument. The financial entity uses the processed categorization information to generate a report for the user. The financial entity stores the processed categorization information in an electronic storage for the user. The user then uses a financial management module to access the stored categorization information and to generate financial data.

### BACKGROUND OF THE INVENTION

1. Field of the Invention

The present invention is related to categorizing a financial transaction, and more particularly to allowing a user to categorize a financial transaction at the time of the transaction.

2. Description of the Background Art

When a user conducts a financial transaction, it is desirable to record the financial transaction. For example, a given financial transaction has various ramifications: the transaction can be deductible for income tax reporting purposes, the transaction can be qualified for certain reimbursements, the user may wish to record the transaction to create a budget, or the user may simply wish to have an itemized report on what was spent on. Thus, proper recording of a financial transaction is generally desired.

There are several conventional approaches for a user to record a financial transaction. In one approach, a user records a financial transaction after the time of the transaction, using either financial software or a manual record (e.g., a checkbook). For example, after buying groceries at a grocery store, a user may later record what items or types of items he or she purchased. The disadvantage of this approach is that there is a delay between the, time of the transaction and the time of the recording. Accordingly, the user may not remember the amount that was spent or the purpose of the transaction when he or she later attempts to record the transaction.

Another approach allows the user to record the transaction at the time of the transaction. For example, some personal checks have carbon copies that automatically record the payee, amount, and date of a transaction. After the user writes a check, he or she further records additional information on the corresponding carbon copy. The carbon copy can also provide a checkbox that allows the user to designate a category of the payment. For example, the carbon copy can have a “charitable donation” category, which indicates that the amount was paid to a charity. Thereafter, the user manually uses the payment category as indicated on the carbon copy to, for example, make-an itemized report, create a budget, etc. The user can also later transfer this information manually to a server or financial software.

Some other approaches allow the user to automatically record a financial transaction to an electronic device at the time of the transaction. For example, a user places a check on top of an electronic device and then writes the check. The electronic device includes handwriting recognition capabilities such that it automatically records what was written on the check. Accordingly, after completion of the financial transaction, the user has an electronic record of the transaction, for example, at a financial entity or in financial software.

In these approaches, the user either has to record a transaction after the time of the transaction or needs a special device or medium to record the transaction. Furthermore, after recording the transaction, the user has to manually gather the information to generate a report, summary, or other information based on the recording.

What is desired, then, is a technique for allowing a user to categorize a financial transaction at the time of the transaction and on the same financial instrument (e.g., personal check, cashier's check, teller's check, traveler's check, money order, credit card, debit card, direct deposit, automatic or wire transfer, fund or cash withdrawal, electronic money, etc.) used to conduct the transaction, in order to improve the efficiency and reliability of transaction categorizations.

What is further desired is a technique for automatically generating data based on the transaction categorizations recorded by the user, in order to provide improved financial information to the user.

### SUMMARY OF THE INVENTION

The present invention provides users with an improved way to indicate categories of financial transactions such as commercial transactions, investment transactions, banking transactions, and credit transactions. The invention allows users to record categorization information on a financial instrument used to conduct a financial transaction such that the categorization information is recorded at the time of the transaction and need not be manually transferred to financial software or other storage.

The present invention provides a variety of financial instruments that allow a user to record categorization information. Exemplary financial instruments include, but are not limited to, personal check, cashier's check, teller's check, traveler's check, money order, credit card, debit card, direct deposit, automatic or wire transfer, fund or cash withdrawal, electronic money. A user records one or more categories for a financial transaction on a financial instrument (e.g., via one or more checkboxes on the financial instrument). The user can specify his or her own categories. The user can further allocate a portion of the transaction amount to a particular category and another portion of the transaction amount to another category.

When a financial entity processes the financial instrument to complete the financial transaction, it also processes the categorization information recorded on the financial instrument. An embodiment of the invention provides that the financial entity uses the recorded categorization information to generate a report. Accordingly, the user can access, change, or view the report electronically (e.g., online access) or physically. In an alternative embodiment of the invention, the financial entity stores the processed categorization information in an electronic storage per each user. A user can then use a financial management module (or software) to access, change, or view the stored categorization information.

According to an embodiment of the invention, the financial management module further processes the accessed categorization information to generate various financial data for the user. For example, the financial management module can automatically create a tax return statement (e.g., Schedule C in the tax return), financial statement, budget plan, expense summary, etc. for the user based on the categorization information.

In one embodiment, the invention is implemented as a tool for developing financial data within a financial management module executed on a client machine. In another embodiment, the invention is implemented as a stand-alone report module that uses categorization information to generate a report.

These techniques allow the creation of financial data that does not depend on specific types of financial instruments being used by a user, and that further reduces manual processing of the categorization information by the user. Instead, categorization information is processed by a financial entity handling the financial instrument and a financial management module that manipulates financial data, thus minimizing user involvement.

### BRIEF DESCRIPTION OF THE DRAWINGS

The accompanying drawings illustrate several embodiments of the invention and, together with the description, serve to explain the principles of the invention.

FIG. 1 is a block diagram depicting functional components for practicing the present invention, according to an embodiment.

FIG. 2 is an event diagram depicting a method of categorizing a financial transaction according to an embodiment of the invention.

FIG. 3 is a block diagram depicting an exemplary architecture of a client machine according to an embodiment of the invention.

FIG. 4 is a block diagram depicting an exemplary network environment for practicing the present invention, according to an embodiment.

FIGS. 5A and 5B are illustrations of an exemplary financial instrument layout format for a check, according to an embodiment of the invention.

FIGS. 6A and 6B are illustrations of an exemplary financial instrument layout format for an automated teller machine, according to an embodiment of the invention.

FIG. 7 is an illustration of an exemplary financial instrument layout format for an electronic credit card transaction, according to an embodiment of the invention.

FIG. 8 is an illustration of an exemplary online financial instrument layout format, according to an embodiment of the invention.

FIG. 9 is an illustration of an exemplary financial report/record, according to an embodiment of the invention.

FIG. 10 is an illustration of exemplary financial data, according to an embodiment of the invention.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF A PREFERRED EMBODIMENT

The following description of system components and operation is merely exemplary of embodiments of the present invention. One skilled in the art will recognize that the various designs, implementations, and techniques described herein can be used alone or in any combination, and that many modifications and equivalent arrangements can be used. Accordingly, the following description is presented for purposes of illustration, and is not intended to limit the invention to the precise forms disclosed.

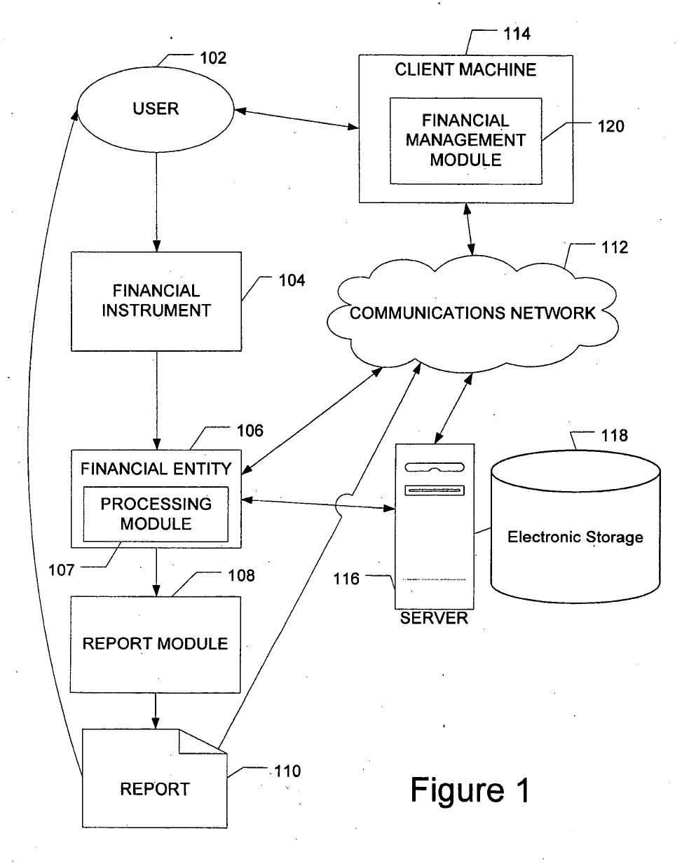

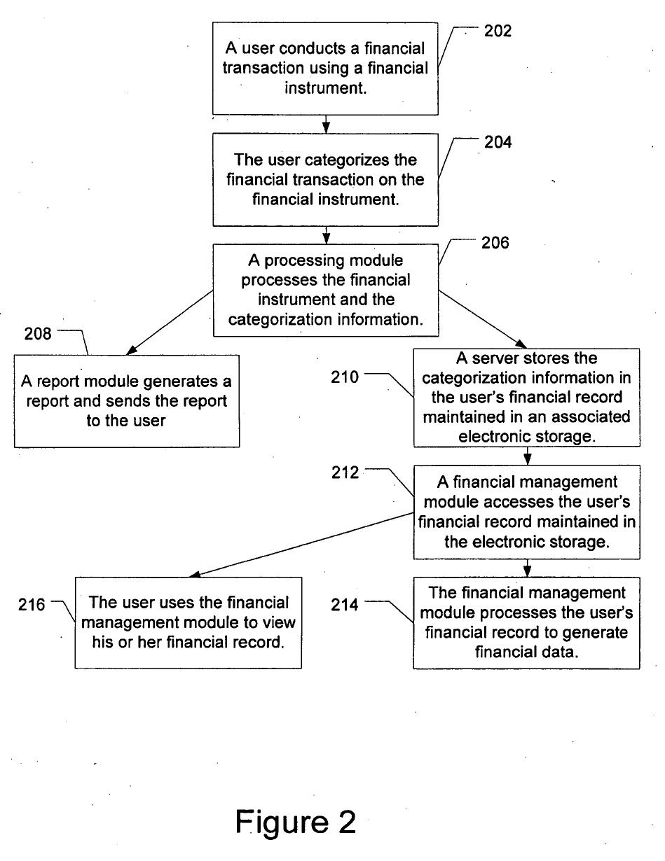

Referring to FIG. 1, a block diagram depicts an overall architecture for practicing the present invention, according to an embodiment. Referring also to FIG. 2, an event diagram depicts a method of categorizing a financial transaction according to an embodiment of the invention. One skilled in the art will recognize that the particular system components shown in FIG. 1, and the particular method steps and sequence shown in FIG. 2, are merely exemplary and that many other variations are possible without departing from the essential characteristics of the invention.

A user 102 (e.g., a consumer) conducts 202 a financial transaction using a financial instrument 104. The financial transaction can be a commercial transaction such as the purchase of goods and/or services. The financial transaction can also be an investment transaction (e.g., stock/bond purchases). The financial transaction can further be a banking transaction (e.g., fund transfer, cash withdrawal, deposit) or a credit transaction (e.g., loan). In general, any transaction that involves monetary means can be characterized as a financial transaction.

There are various ways for user 102 to conduct the financial transaction. According to an embodiment of the invention, user 102 conducts the financial transaction by using the financial instrument 104. Examples of financial instrument 104 include, but are not limited to, personal check, cashier's check, teller's check, traveler's check, money order, credit card, debit card, direct deposit, automatic or wire transfer, fund or cash withdrawal, electronic money. One skilled in the art will recognize that the invention is not limited to the described examples but is applicable to various other instruments or monetary means currently existing or that may be developed in the future.

Typically, after user 102 conducts the financial transaction using financial instrument 104, a financial entity 106 processes financial instrument 104. For example, after user 102 purchases an item using a personal check, the vendor provides the personal check to its bank for deposit into its bank account. The vendor's bank then communicates with the bank of user 102 from which the personal check was issued to clear the monetary amount of the personal check. The bank of user 102 then transfers the monetary amount from the bank account of user 102 to the vendor's bank account (e.g., crediting the vendor's bank account and debiting the bank account of user 102) to complete the transaction. Thus in this example, two financial entities 106—the vendor's bank and the bank of user 102—process financial instrument 104 (i.e., the personal check in this example).

In another example, user 102 uses a credit card to purchase an item on a website. After user 102 submits his or her credit card information and completes the purchasing transaction, the website communicates with the credit card issuer to obtain the monetary amount of the purchasing transaction. Accordingly, the credit card issuer is the financial entity 106 processing financial instrument 104 (i.e., the credit card transaction in this example).

In yet another example, user 102 withdraws cash from his or her bank account using an automated teller machine (ATM). If the ATM is established by the bank of user 102, this bank completes the transaction by debiting the bank account of user 102. If the ATM is established by another bank different from the bank of user 102, the other bank communicates with the bank of user 102 to debit the bank account of user 102 and credit the other bank's account. In both situations, the bank of user 102 is the financial entity 106 processing financial instrument 104 (i.e., the ATM transaction in this example).

One skilled in the art will recognize that embodiments of the invention can be practiced with various types of financial entities currently existing or that may be developed in the future.

According to an embodiment of the invention, when user 102 conducts the financial transaction using financial instrument 104, he or she categorizes 204 the financial transaction on financial instrument 104. For example, when user 102 writes a personal check to donate a monetary amount to a charitable organization, he or she can characterize the personal check transaction as a “charitable donation.” In addition, when user 102 purchases grocery at a grocery store using a credit card, he or she can characterize the credit card transaction as a “grocery shopping expense.” In another example, when user 102 makes a wire transfer to purchase a car, he or she can characterize the wire transfer as a “car payment.” It is noted that there are many possible categories, and embodiments of the invention can be practiced without regard to how a particular category is characterized or defined.

User 102 can record a category for the financial transaction on financial instrument 104 via any of several ways. For example, financial instrument 104 is provided with different categories such that user 102 can select one or more categories to indicate the type(s) of the transaction. Thus, a personal check issued by a bank can have different categories such as “charitable donation,” “grocery shopping expense,” “car payment,” etc. printed on it. The categories can be printed on the personal check as checkboxes or some other forms for user 102 to select which one or more categories that the financial transaction corresponds to. In another example, when user 102 accesses his or her bank account on a website or on an ATM, the webpage or screen displays a list of categories for user 102 to choose from.

In another way, user 102 can manually write or record a category for the transaction on financial instrument 104. For example, if user 102 uses a personal check to purchase groceries, he or she can characterize the transaction, for example, by writing “grocery shopping expense” (or a code such as a number) on the personal check before giving the personal check to the clerk as a payment. User 102 can also electronically record the transaction category on financial instrument 104 (e.g., to an ATM, website, etc.) via a keyboard, a digital pen and a writable screen, or other means.

In yet another way, other information recorded on financial instrument 104 indicates the transaction's category. According to an embodiment of the invention, the presence of a particular piece of information (e.g., transaction date, amount, location, party) on financial instrument 104 suggests a default category for the financial transaction. A default category can be set up automatically by observing the behaviors of user 102. Thus, when user 102 has conducted financial transactions with a particular party over a number of times and has indicated at some time a category for these financial transactions, a processing module 107 used by financial entity 106 automatically assigns transactions involving this party to the indicated category. A default category can also be set up based on an identity of a payee recorded on financial instrument 104. Thus, the processing module 107 according to an embodiment of the invention automatically assigns the category “office supplies” to financial transactions in which the payee is Office Depot. Furthermore, a default category can also be set up in accordance with an instruction from user 102 (whether via financial instrument 104 or via other means). For example, user 102 can record “default category: office supplies” on financial instrument 104 such that transactions involving the same payee are automatically assigned to the “office supplies” category. Processing module 107 can also break down financial instrument 104 by each item paid. As an example, processing module 107 can break down office supplies down into paper, computer products, pen and pencils, and taxes paid. Regardless of how a default category was set up, user 102 can override, terminate, or change the default category at any time (whether via financial instrument 104 or via other means).

To illustrate, when user 102 for the first time donates to the American Red Cross using a personal check, he or she indicates on the personal check that the payee is the American Red Cross and that the transaction's category is “charitable donation.” User 102 also records on the personal check that the default category for transactions involving the American Red Cross is “charitable donation.” Alternatively, user 102 records on the personal check that a default category should not be set based on this transaction. If a default category is set, the category for subsequent financial transactions involving the American Red Cross is “charitable donation,” even if user 102 does not record a specific category in the subsequent transactions. However, user 102 can override the default category by, for example, recording another category on financial instrument 104 for a subsequent transaction involving the American Red Cross (and indicating on the financial instrument 104 that this is an override to the default category). User 102 can also indicate on financial instrument 104 that the default category for transactions involving the American Red Cross is changed to “medical services” or is otherwise terminated.

According to an embodiment of the invention, user 102 can also customize a default categorization via financial instrument 104 or via other means. For example, user 102 can set up multiple default categories per financial transaction. User 102 can also set up a default allocation such that processing module 107 automatically assign a given percentage of a transaction amount to a category, another percentage of the transaction amount to another category, and so on.

It is noted that embodiments of the invention can be practiced without regard to how user 102 records the categorization information on financial instrument 104.

After user 102 categorizes the financial transaction on financial instrument 104, financial instrument 104 is provided to financial entity 106 for processing. Accordingly, the categorization information of the financial transaction becomes available to financial entity 106. Processing module 107 thus processes 206 the financial instrument and the categorization information. According to an embodiment of the invention, financial entity 106 can process the categorization information via a variety of ways. For example, financial entity 106 can manually determine the transaction's category as indicated on financial instrument 104 and manually enter the determined category in a database associated with user 102. In another way, financial entity 106 can use a scanner to digitally scan the content of financial instrument 104 and processing module 107 to automatically recognize the scanned content. The processing module 107 automatically determines the transaction's category based on the scanned content (e.g., from the recorded category, payee information, etc.). Alternatively, financial entity 106 uses an optical character reader (OCR) to scan and recognize the content of financial instrument 104. In yet another way, if user 102 records information on financial instrument 104 electronically (e.g., via an ATM or website), the recorded information is electronically transmitted to processing module 107 for processing to determine the transaction's category.

In an embodiment of the invention, financial entity 106 may provide financial instrument 104 directly to a server 116 without processing the categorization information. The server 116, which includes a processing module 107, processes the categorization information recorded on financial instrument 104 and stores this information in an electronic storage 118. Server 116 may automatically process the categorization information, for example, via a scanner or an OCR. As an example, financial entity 106 may transfer check images to server 116 along with the electronic data tags containing the check numbers and amounts. Server 116 may use its processing module 107 to process the check images and the data tags to determine the financial transaction's category based on the categorization information recorded on financial instrument 104. This information is stored in electronic storage 118 for later access by user 102.

Financial entity 106 may also provide financial instrument 104 to server 116 via a third party. Specifically, the third party obtains financial instrument 104 from financial entity 106 to perform some pre-processing steps such as scanning financial instrument 104 or otherwise gathering information recorded on financial instrument 104 before sending information regarding financial instrument 104 to server 116, thereby reducing the processing load on server 116.

After financial entity 106 (or server 116) processes the categorization information, a report module 108 generates 208 a report 110 for presenting to user 102. In particular, the report module 108 generates the report 110 based on the categorization information. Financial entity 106 then provides report 110 to user 102 either physically or electronically. For example, financial entity 106 can send report 110 to user 102 via traditional mail. In another example, financial entity 106 can provide report 110 to user 102 electronically via a communications network 112 (e.g., the Internet). User 102 interacts with a client machine 114 to receive report 110 from financial entity 106 via the communications network 112. For example, user 102 can use the client machine 114 to obtain a printout of report 110 or view report 110 on the screen of client machine 114.

According to an exemplary embodiment of the invention, report 110 lists one or more financial transactions conducted by user 102. For each listed financial transaction, report 110 identifies the date, amount, one or more recorded categories, party (e.g., payee), location, and/or other information of the transaction. Report 110 arranges the financial transactions according to various criteria. In an embodiment of the invention, report 110 groups the financial transactions into different categories and sorts the financial transactions under each category by some other criteria (e.g., dates, amounts, locations, payees, etc.). For example, transactions under the category “charitable donation” are grouped separately from transactions under the category “car payment” in report 110. Transactions under the category “charitable donation” are further sorted in report 110 based on transaction dates, amounts, payees, locations, etc. In another embodiment of the invention, report 110 sorts the financial transactions based on some other criteria such as transaction dates, amounts, parties, locations, etc., with each entry indicating the transaction's category.

In an embodiment of the invention, financial entity 106 is associated with a server 116, which is further associated with a memory area such as an electronic storage 118. Via the server 116, financial entity 106 stores 210 the categorization information of user 102 in the electronic storage 118. Server 116 maintains a financial record of user 102 in electronic storage 118. When server 116 receives the categorization information from financial entity 106 (e.g., via communications network 112), it adds an entry to the financial record. Each entry in the financial record corresponds to a financial transaction conducted by user 102 and includes the categorization information to indicate the financial transaction's category. Financial entity 106 can store the categorization information in electronic storage 118 in addition to or in lieu of report module 108 generating report 110.

FIG. 1 depicts user 102 interacting with client machine 114. Client machine 114 can be implemented as any conventional, general purpose computer such as a desktop computer, laptop computer, handheld device, personal digital assistant (PDA), or any other device that allows user 102 to interact with server 116.

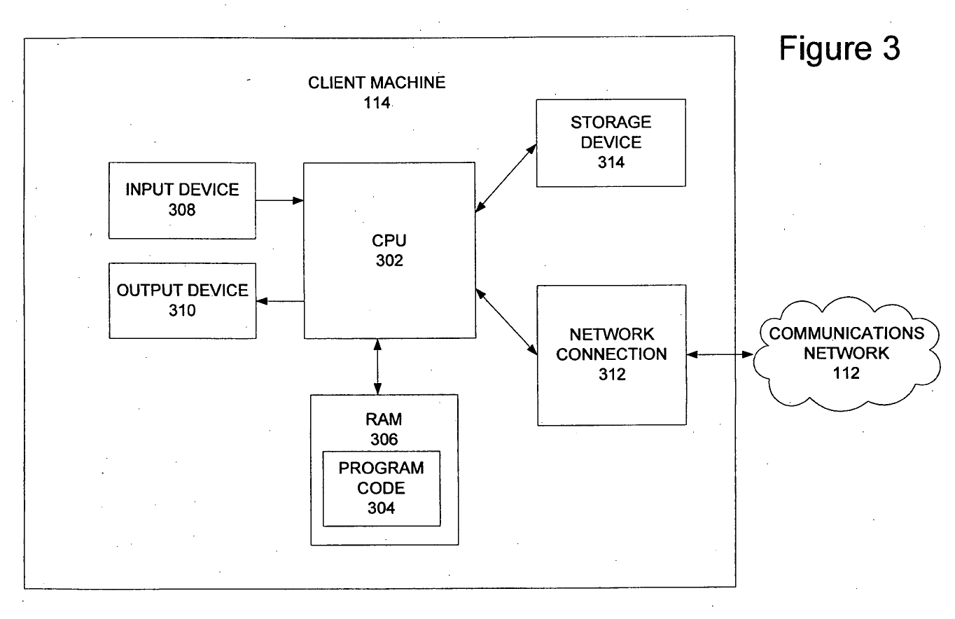

Referring also to FIG. 3, there is shown a block diagram depicting an example of an architecture for client machine 114. As shown in FIG. 3, client machine 114 can be a conventional computer such as a personal computer running an operating system. Client machine 114 includes a central processing unit (CPU) 302 for performing operations and functions as specified in program code 304. Program code 304 can be stored in any storage medium, such as a hard drive, compact disc read-only memory (CD-ROM), and the like. While it is being executed, program code 304 is temporarily read into a random access memory (RAM) 306 so that it can easily be read and executed by the CPU 302 according to techniques that are well known in the art.

An input device 308, such as a keyboard and/or mouse, allows the user to provide input for interacting with the functionality of the present invention. An output device 310, such as a display screen, displays output including that of the operating system, active applications, and the like. Such output typically includes dialog boxes and other status messages concerning the status of various operations running on client machine 114. Client machine 114 also includes a network connection device 312, such as a modem, cable modem, Ethernet card, or the like, for connecting to communications network 112, according to techniques that are well known in the art, so as to enable uploading, downloading, and interacting with network-connected resources. A storage device 314, which can be implemented as a hard drive or other device, includes various files and resources for use by the software in performing the functions of the present invention.

One skilled in the art will recognize that FIG. 3 is merely exemplary, and that the invention can be practiced on systems having other configurations and components. For example, the functionality of the invention can be implemented in a network-based application such as can be provided by an application service provider (ASP); in such an embodiment, most of the functions described below as being performed by client machine 114 could be performed by a remotely located application server (not shown), according to techniques that are well known in the art.

Referring again to FIG. 1, a financial management module (or software) 120 is executed on client machine 114. User 102 utilizes the financial management module 120 to interact with server 116. Specifically, financial management module 120 communicates with server 116 via communications network 112. If server 116 determines that financial management module 120 has the proper security rights to access the financial record of user 102 maintained in electronic storage 118, it allows financial management module 120 to access 212 the financial record of user 102. Accordingly, financial management module 120 downloads the financial record from electronic storage 118 to client machine 114 for presenting to user 102 via the output device 310 of client machine 114. Financial management module 120 also processes 214 the financial record of user 102 to generate various financial data. In one embodiment, financial management module 120 can use the categorization information included in the financial record to create a budget, financial report/statement, tax return statement, expense summary, or other regulatory compliance documents for user 102. For example, user 102 may provide categorization information on financial instrument 104 that corresponds to an expense category in Schedule C of his or her tax return. Accordingly, financial management module 120 may automatically complete the tax return of user 102, in particular Schedule C, by using the categorization information on financial instrument 104. As a result, user 102 saves the effort to manually fill out Schedule C in preparing his or her income tax return.

User 102 uses 216 financial management module 120 to view his or her financial record. According to an embodiment of the invention, user 102 can further use financial management module 120 to arrange his or her financial record into various formats for viewing. Thus, user 102 can organize the entries in the financial record based on different categories of financial transactions. For example, user 102 can group entries corresponding to the category “charitable donation” together and sort the entries under this category according to some other criteria such as transaction dates, amounts, parties, locations, etc. Alternatively, user 102 can organize the entries in the financial record based on some other criteria such as transaction dates, amounts, parties, locations, etc., with each entry indicating the transaction's category.

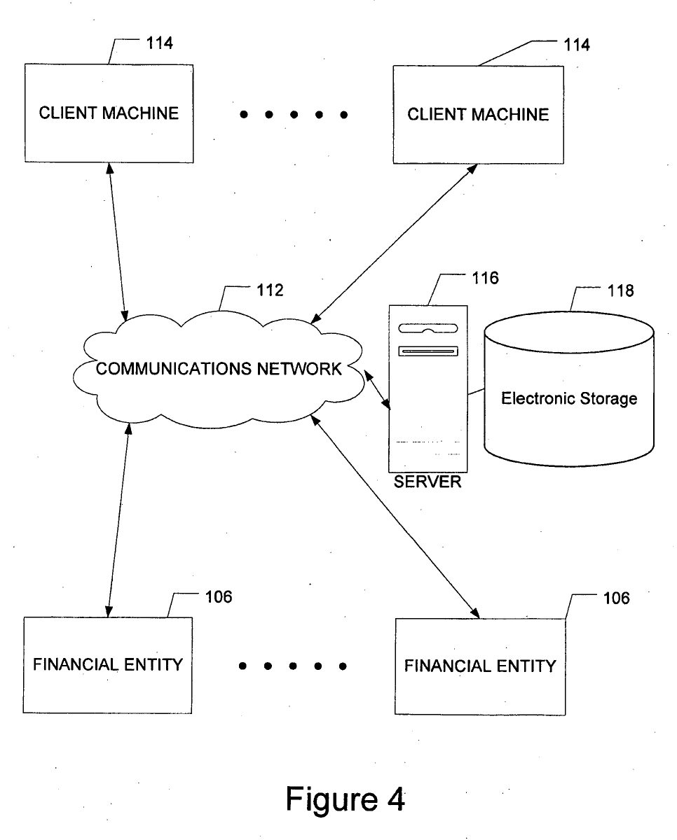

In an embodiment of the invention, server 116 and electronic storage 118 serve as the central processing unit and storage for a plurality of financial entities 106 and client machines 114, as illustrated in FIG. 4. More specifically, various financial entities 106 can process different financial instruments 104 used by a particular user 102, and electronic storage 118 is the central storage for storing financial records of the user 102 that correspond to the different financial instruments 104. For example, a particular user 102 can conduct two different financial transactions using two different financial instruments 104. The first financial instrument 104 is processed by a first financial entity 106, and the second financial instrument 104 is processed by a second financial entity 106. Both financial entities 106 access electronic storage 118 via server 116 to store the categorization information of each financial transaction. Specifically, both financial entities 106 add entries to one or more financial records maintained in electronic storage 119. Accordingly, the user 102 can access electronic storage 118 using a client machine 114 to obtain his or her financial record including both transactions' categorization information.

Electronic storage 118 can also store financial records of different users 102 who use different client machines. In one embodiment, server 116 can enforce a security mechanism such that a user cannot access a different user's financial record. It is also noted that the same financial entity 106 can process different users' financial instruments 104. Thus, the same financial entity 106 can store different users' categorization information in their corresponding financial records in electronic storage 118.

In an embodiment of the invention, the categorization information stored in electronic storage 118 may be shared among multiple users. Thus, based on the categorization information, a database of categories for each payee may be created. This database of payee categories allows categorization of transactions involving certain payees (e.g., those that sell primarily the same type of product or service over time) whose categories are stored in the database, even if users did not categorize such transactions. For example, if a user categorizes a transaction with Office Depot as “office supplies,” this categorization information may be available to other users such that the transactions of the other users with Office Depot are also automatically categorized as “office supplies,” even if the other users did not categorize their transactions. Alternately, the other users may have the opportunity to choose the automatic categorization provided by electronic storage 118 or to supply their own categories for the transactions.

One skilled in the art will recognize that the invention can be implemented in other environments and according to other functional architectures, including non-client/server environments and distributed server/electronic storage environments. For example, the invention can be implemented in a single computer or it can be implemented as a distributed software application across any number of connected computers.

The following text provides examples of the various types of financial instruments for which embodiments of the invention can be practiced.

Check

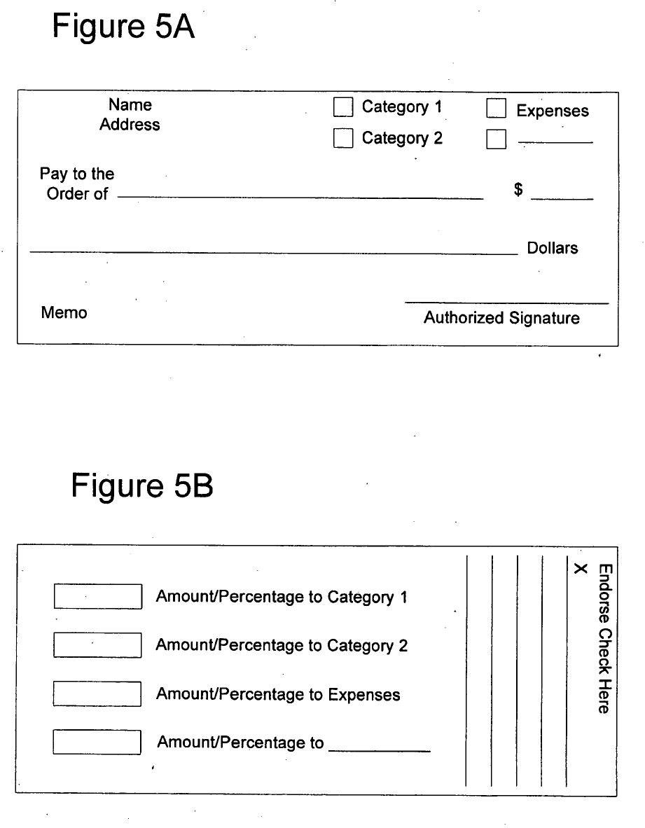

FIGS. 5A and 5B illustrate an exemplary check such as a personal check, cashier's check, teller's check, money order, traveler's check, according to an embodiment of the invention. FIG. 5A illustrates the front side of the exemplary check. The front side of the check is printed with one or more categories (e.g., category 1, category 2, expenses, and a blank field for user 102 to fill in his or her own category) from which the user can characterize the financial transaction. FIG. 5B illustrates the backside of the exemplary check, which is printed with multiple fields for user 102 to allocate the transaction amount. For example, user 102 can allocate a specific amount or percentage of the total transaction amount to a particular category.

After user 102 fills out the check and provides the check to a vendor, the vendor submits the check to a financial entity 106 such as a commercial bank. The financial entity 106 processes the financial transaction (e.g., crediting the transaction amount to the vendor's bank account and debiting the transaction amount from the bank account of user 102). Financial entity 106 also processes the categorization information to generate a report 110 and/or to create an entry in a financial record of user 102 (which is stored in electronic storage 118).

ATM

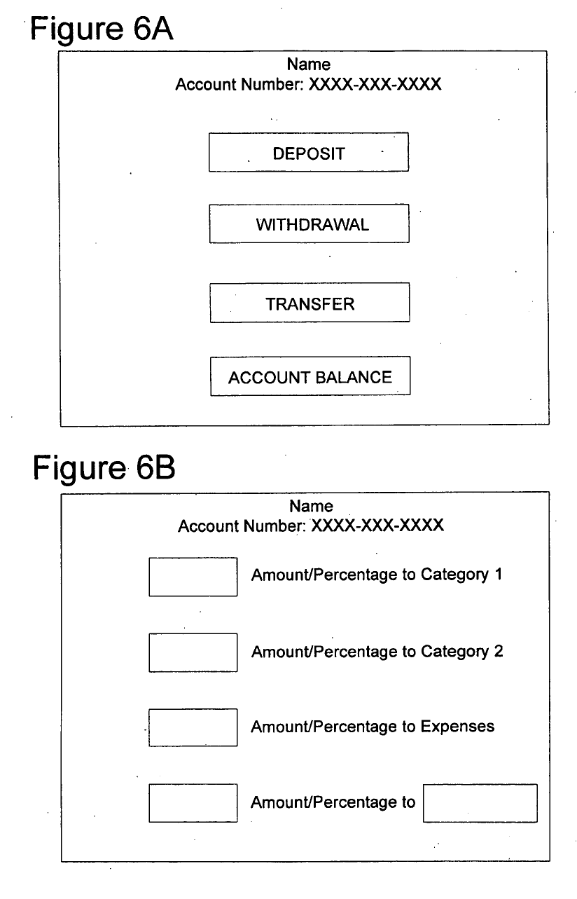

FIGS. 6A and 6B illustrate exemplary screenshots of an ATM, according to an embodiment of the invention. FIG. 6A illustrates a typical ATM screen from which user 102 can conduct different banking transactions (i.e., financial transactions) such as deposit, withdrawal, transfer, account balance inquiry, etc. After user 102 selects a particular banking transaction in the ATM screen illustrated in FIG. 6A, the ATM screen illustrated in FIG. 6B presents user 102 an opportunity to characterize the banking transaction. User 102 can create his or her own category and can allocate a specific amount or percentage of the total transaction amount to a particular category. When a financial entity 106 (e.g., a commercial bank) processes the banking transaction, it also processes the categorization information to generate a report 110 and/or to create an entry in a financial record of user 102 (which is stored in electronic storage 118).

Credit or Debit Card Transaction at a Physical Location

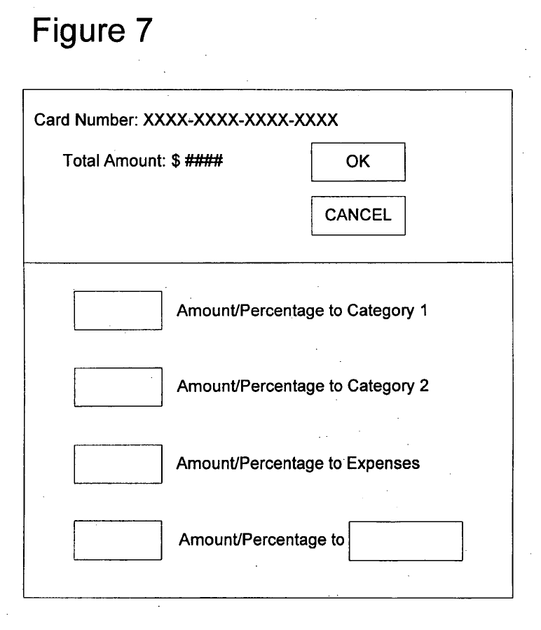

FIG. 7 illustrates an exemplary screenshot of a credit/debit card transaction device installed at a physical location, according to an embodiment of the invention. For example, user 102 may use his or her credit/debit card to purchase goods or services at a physical store. After user 102 or a clerk inputs the card number (e.g., scanning the magnetic stripe of the card), the credit/debit card transaction device presents a screen showing the transaction amount and requesting user 102 to confirm the transaction. The screen also provides one or more categories for user 102 to characterize the transaction. User 102 can also input his or her own desired category. User 102 can further specify an amount or percentage of the total transaction amount to a particular category. After the transaction is complete, a financial entity 106 (e.g., the card issuer) processes the transaction and the corresponding categorization information to generate a report 110 and/or to create an entry in a financial record of user 102 (which is stored in electronic storage 118).

Credit or Debit Card Transaction at a Website

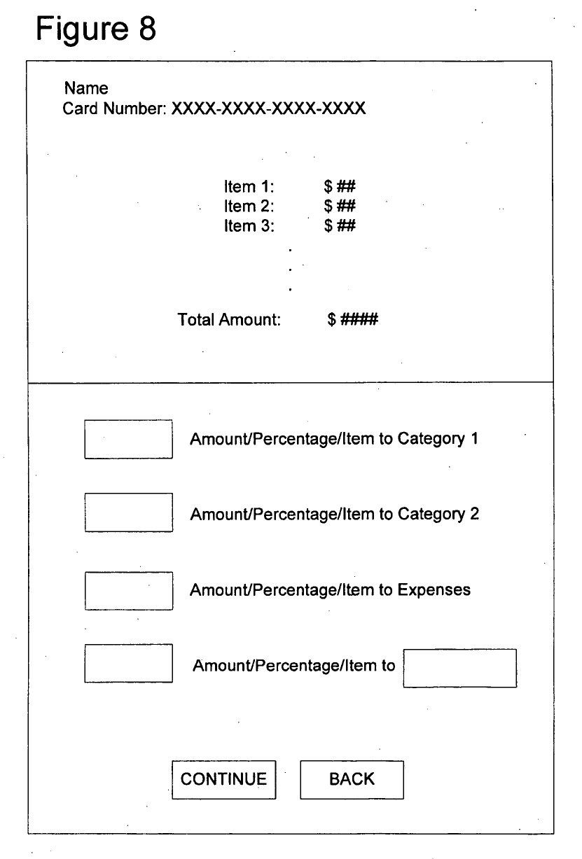

FIG. 8 illustrates an exemplary screenshot of a website, according to an embodiment of the invention. In one embodiment of the invention, user 102 may conduct a financial transaction online using a credit card, debit card, electronic money, or any other forms of electronic payment. After user 102 visits a website and is ready to complete the financial transaction, the website presents a webpage showing a list of items involved in the transaction (e.g., purchased) and the transaction amount. The webpage also provides a list of categories for user 102 to characterize the transaction. User 102 can also specify his or her category in a blank field: User 102 can further allocate a specific amount, percentage, or item to a particular category. After user 102 completes and submits the webpage to a server, the website provides the financial and categorization information to a financial entity 106, which then processes the financial transaction and the categorization information to generate a report 110 and/or to create an entry in a financial record of user 102 (which is stored in electronic storage 118).

Financial Record or Report with Categorization Information

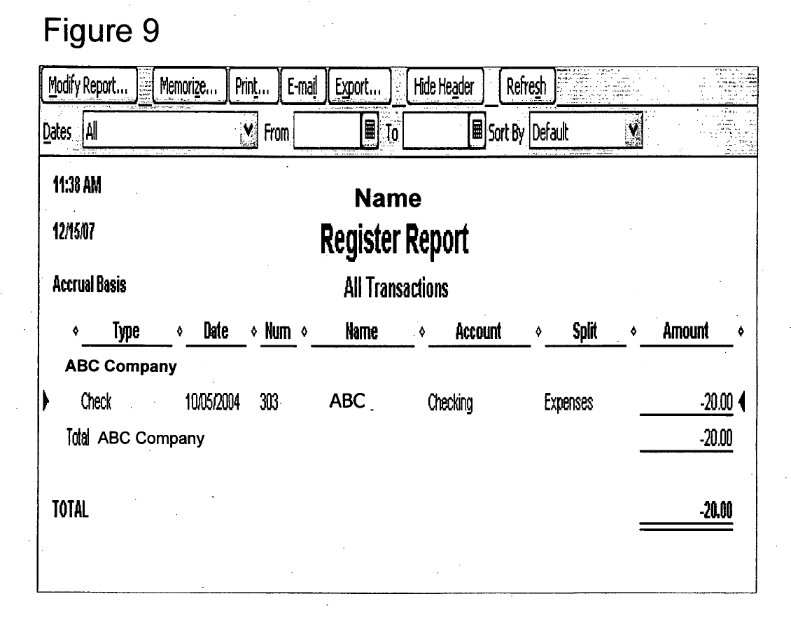

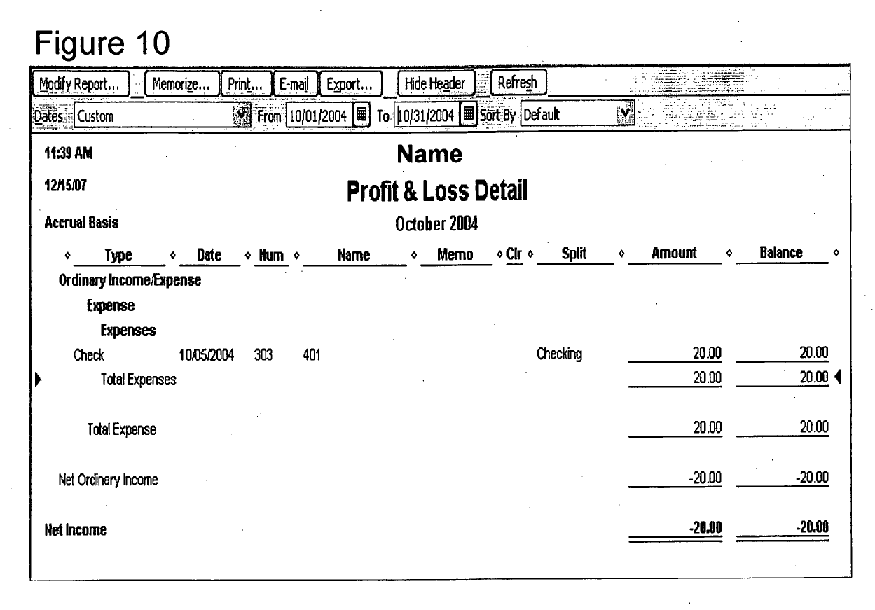

FIG. 9 illustrates an exemplary financial record or report provided to user 102 with categorization information, according to an embodiment of the invention. As shown in FIG. 9, the financial record or report provides user 102 a breakdown of past financial transactions, along with a categorization of each transaction (e.g., check number 303 paid to ABC company is categorized as “expenses”). In another embodiment of the invention, financial management module 120 automatically uses the categorization information processed by financial entity to generate financial data (e.g., budget, financial report/statement, tax return statement, expense summary, or other regulatory compliance documents) for user 102. For example, FIG. 10 shows a profit/loss statement in which financial management module 120 automatically deducts amounts categorized as “expenses” from the income of user 102 to derive the profit. Accordingly, embodiments of the invention ease the creation of financial data for various purposes, such as budgeting, planning, regulatory compliance, reporting, and accounting.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The present invention also relates to an apparatus for performing the operations herein. This apparatus can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer, network of computers, or other apparatus. Various general-purpose systems can be used with programs in accordance with the teachings herein, or it can prove convenient to construct a more specialized apparatus to perform the required method steps. The required structure for a variety of these systems appears from the description. In addition, the present invention is not described with reference to any particular programming language. It will be appreciated that a variety of programming languages can be used to implement the teachings of the invention as described herein.

As will be understood by those familiar with the art, the invention can be embodied in other specific forms without departing from the spirit or essential characteristics thereof. For example, the particular architectures depicted above are merely exemplary of one implementation of the present invention. The functional elements and method steps described above are provided as illustrative examples of one technique for implementing the invention; one skilled in the art will recognize that many other implementations are possible without departing from the present invention as recited in the claims. Likewise, the particular capitalization or naming of the modules, protocols, features, attributes, or any other aspect is not mandatory or significant, and the mechanisms that implement the invention or its features can have different names or formats. In addition, the present invention can be implemented as a method, process, user interface, computer program product, system, apparatus, or any combination thereof. Accordingly, the disclosure of the present invention is intended to be illustrative, but not limiting, of the scope of the invention, which is set forth in the following claims.

What is claimed is:

1. A method for automatically categorizing a financial transaction, the method comprising:
receiving a financial instrument from a user, the financial instrument indicating a category of a financial transaction conducted by the user using the financial instrument;
processing the financial instrument to determine the category of the financial transaction; and
storing the category of the financial transaction in a memory area.

2. The method of claim 1, wherein the financial instrument comprises at least one selected from the group consisting of: a personal check, a cashier's check, a teller's check, a traveler's check, a money order, a credit card, a debit card, direct deposit, automatic transfer, wire transfer, fund withdrawal, cash withdrawal, and electronic money.

3. The method of claim 1, wherein processing the financial instrument comprises processing the financial instrument to determine the category of the financial transaction at a financial entity.

4. The method of claim 1, further comprising:
generating a report including the category of the financial transaction; and
providing the generated report to the user.

5. The method of claim 4, wherein:
the report identifies a plurality of financial transactions conducted by the user; and
the plurality of financial transactions are grouped in the report based on categories of financial transactions.

6. The method of claim 4, wherein
the report identifies a plurality of financial transactions conducted by the user; and
the plurality of financial transactions are ordered based on a criteria other than financial transaction category.

7. The method of claim 1, wherein storing the category of the financial transaction comprises adding an entry to a financial record of the user maintained in the memory area, the entry including the category of the financial transaction.

8. The method of claim 7, further comprising:
providing the financial record to the user; and
generating financial data of the user based on the category of the financial transaction included in the financial record.

9. The method of claim 8, wherein the financial data comprises at least one selected from the group consisting of: a budget, a financial report, a financial statement, a tax return statement, an expense summary, and a regulatory compliance document.

10. The method of claim 8, wherein providing the financial record to the user comprises providing the financial record to the user via a financial management module.

11. The method of claim 1, wherein:
the financial instrument indicates the category of the financial transaction using information regarding the financial transaction; and
processing the financial instrument to determine the category of the financial transaction comprises determining the category of the financial transaction using the information regarding the financial transaction.

12. The method of claim 11, wherein the information regarding the financial transaction comprises at least one selected from the group consisting of: transaction date, transaction amount, transaction location, and transaction party.

13. The method of claim 1, wherein the category of the financial transaction is recorded on the financial instrument by the user manually.

14. The method of claim 1, wherein the category of the financial transaction is recorded on the financial instrument by the user electronically.

15. The method of claim 1, further comprising:
storing the category of the financial transaction indicated on the financial instrument as a default category.

16. The method of claim 1, wherein processing the financial instrument to determine the category of the financial transaction comprises determining a default category of the financial transaction.

17. The method of claim 16, wherein determining the default category of the financial transaction comprises determining the default category based on a behavior of the user in conducting one or more financial transactions.

18. The method of claim 16, wherein the category indicated on the financial instrument represents an override to the default category for the financial transaction.

19. A system for automatically categorizing a financial transaction, the system comprising:
an input device for recording a financial instrument used by a user to conduct a financial transaction;
a processing module for determining a category of the financial transaction, the category of the financial transaction being indicated on the financial instrument; and
a memory area for storing the category of the financial transaction.

20. The system of claim 19, wherein the financial instrument comprises at least one selected from the group consisting of: a personal check, a cashier's check, a teller's check, a traveler's check, a money order, a credit card, a debit card, direct deposit, automatic transfer, wire transfer, fund withdrawal, cash withdrawal, and electronic money.

21. The system of claim 19, wherein the processing module is associated with a financial entity processing the financial instrument.

22. The system of claim 19, further comprising:
a report module for:
generating a report including the category of the financial transaction; and
providing the generated report to the user.

23. The system of claim 22, wherein:
the report identifies a plurality of financial transactions conducted by the user; and
the plurality of financial transactions are grouped in the report based on categories of financial transactions.

24. The system of claim 22, wherein
the report identifies a plurality of financial transactions conducted by the user; and
the plurality of financial transactions are ordered based on a criteria other than financial transaction category.

25. The system of claim 19, wherein the processing module adds an entry to a financial record of the user maintained in the memory area, the entry including the category of the financial transaction.

26. The system of claim 25, further comprising:
a financial management module for:
providing the financial record to the user; and
generating financial data of the user based on the category of the financial transaction included in the financial record.

27. The system of claim 26, wherein the financial data comprises at least one selected from the group consisting of: a budget, a financial report a financial statement, a tax return statement, an expense summary, and a regulatory compliance document.

28. The system of claim 19, wherein:
the financial instrument indicates the category of the financial transaction using information regarding the financial transaction; and
the processing module determines the category of the financial transaction using the information regarding the financial transaction.

29. The system of claim 28, wherein the information regarding the financial transaction comprises at least one selected from the group consisting of: transaction date, transaction amount, transaction location, and transaction party.

30. The system of claim 19, wherein the category of the financial transaction is recorded on the financial instrument by the user manually.

31. The system of claim 19, wherein the category of the financial transaction is recorded on the financial instrument by the user electronically.

32. The system of claim 19, wherein the processing module stores the category of the financial transaction indicated on the financial instrument as a default category.

33. The system of claim 19, wherein the processing module determines a default category of the financial transaction.

34. The system of claim 33, wherein the processing module determines the default category based on a behavior of the user in conducting one or more financial transactions.

35. The system of claim 33, wherein the category indicated on the financial instrument represents an override to the default category for the financial transaction.

36. A computer program product for automatically categorizing a financial transaction, the computer program product comprising:
a computer-readable medium; and
computer program code, encoded on the computer-readable medium for:
receiving a financial instrument from a user, the financial instrument indicating a category of a financial transaction conducted by the user using the financial instrument;
processing the financial instrument to determine the category of the financial transaction; and
storing the category of the financial transaction in a memory area.

37. The computer program product of claim 36, wherein the financial instrument comprises at least one selected from the group consisting of: a personal check, a cashier's check, a teller's check, a traveler's check, a money order, a credit card, a debit card, direct deposit, automatic transfer, wire transfer, fund withdrawal, cash withdrawal, and electronic money.

38. The computer program product of claim 36, wherein the computer program code for processing the financial instrument comprises computer program code for processing the financial instrument to determine the category of the financial transaction at a financial entity.

39. The computer program product of claim 36, further comprising computer program code for:
generating a report including the category of the financial transaction; and
providing the generated report to the user.

40. The computer program product of claim 39, wherein:
the report identifies a plurality of financial transactions conducted by the user; and
the plurality of financial transactions are grouped in the report based on categories of financial transactions.

41. The computer program product of claim 39, wherein
the report identifies a plurality of financial transactions conducted by the user; and
the plurality of financial transactions are ordered based on a criteria other than financial transaction category.

42. The computer program product of claim 36, wherein the computer program code for storing the category of the financial transaction comprises computer program code for adding an entry to a financial record of the user maintained in the memory area, the entry including the category of the financial transaction.

43. The computer program product of claim 42, further comprising computer program code for:
providing the financial record to the user; and
generating financial data of the user based on the category of the financial transaction included in the financial record.

44. The computer program product of claim 43, wherein the financial data comprises at least one selected from the group consisting of: a budget, a financial report a financial statement, a tax return statement, an expense summary, and a regulatory compliance document.

45. The computer program product of claim 43, wherein the computer, program code for providing the financial record to the user comprises computer program code for providing the financial record to the user via a financial management module.

46. The computer program product of claim 36, wherein:
the financial instrument indicates the category of the financial transaction using information regarding the financial transaction; and.
the computer program code for processing the financial instrument to determine the category of the financial transaction comprises computer program code for determining the category of the financial transaction using the information regarding the financial transaction.

47. The computer program product of claim 46, wherein the information regarding the financial transaction comprises at least one selected from the group consisting of: transaction date, transaction amount, transaction location, and transaction party.

48. The computer program product of claim 36, wherein the category of the financial transaction is recorded on the financial instrument by the user manually.

49. The computer program product of claim 36, wherein the category of the financial transaction is recorded on the financial instrument by the user electronically.

50. The computer program product of claim 36, further comprising computer program code for:
storing the category of the financial transaction indicated on the financial instrument as a default category.

51. The computer program product of claim 36, wherein the computer program code for processing the financial instrument to determine the category of the financial transaction comprises computer program code for determining a default category of the financial transaction.

52. The computer program product of claim 51, wherein the computer program code for determining the default category of the financial transaction comprises computer program code for determining the default category based on a behavior of the user in conducting one or more financial transactions.

53. The computer program product of claim 51, wherein the category indicated on the financial instrument represents an override to the default category for the financial transaction.

54. A financial instrument used by a user to conduct a financial transaction, the financial instrument comprising:
a field indicating a category of the financial transaction;
wherein the field indicating the category is provided to a financial entity processing the financial transaction to generate categorization information for the user.

55. The financial instrument of claim 54, comprising at least one selected from the group consisting of: a personal check, a cashier's check, a teller's check, a traveler's check, a money order, a credit card, a debit card, direct deposit, automatic transfer, wire transfer, fund withdrawal, cash withdrawal, and electronic money.

56. The financial instrument of claim 54, wherein the category is recorded by the user manually.

57. The financial instrument of claim 54, wherein the category is recorded by the user electronically.

58. The financial instrument of claim 54, wherein the category represents a default category.

59. The financial instrument of claim 54, wherein the category represents an override to a default category for the financial transaction.
